(19) United States
(12) Patent Application Publication
(10) Pub. No.: US 2004/0181768 A1
(43) Pub. Date: Sep. 16, 2004

(54) Model pattern simulation of semiconductor wafer processing steps

(76) Inventor: Richard H. Krukar, Albuquerque, NM (US)

Correspondence Address: PEACOCK MYERS AND ADAMS P C, P O BOX 26927, ALBUQUERQUE, NM, 871256927

(21) Appl. No.: 10/388,120

(22) Filed: Mar. 12, 2003

(51) Int. Cl. G06F 17/50

(52) U.S. Cl. 716/19

(57) ABSTRACT

Methods and computer program for determining a model pattern of a diffracting structure for use in semiconductor metrology, in which methods a series of process steps to be employed in fabrication of a diffracting structure, such as a diffracting structure fabricated on a semiconductor substrate employing a lithographic process, are specified, and each such specified process step is successively simulated to produce a model pattern of the diffracting structure. The methods further provides for generation of libraries of model patterns and simulated diffraction signatures based thereon, and optionally further provides for comparing diffraction signatures of measured diffracting structures to simulated diffraction signatures of members of the set of model patterns of the diffracting structure, selection of one or more close match simulated diffraction signatures, and deriving one or more parameters associated with the measured diffracting structures.

### BACKGROUND OF THE INVENTION

1. Field of the Invention (Technical Field)

The present invention relates to metrology and process control in semiconductor manufacturing, and more particular to model patterns generated by simulation of semiconductor wafer processing steps and derivative libraries based thereon for use in radiation-based metrology, such as of lithographic or etch steps.

2. Background Art

Note that the following discussion refers to a number of publications by author(s) and year of publication, and that due to recent publication dates certain publications are not to be considered as prior art vis-a-vis the present invention. Discussion of such publications herein is given for more complete background and is not to be construed as an admission that such publications are prior art for patentability determination purposes.

Lithography is used to manufacture semiconductor devices, such as integrated circuits created on wafers, as well as flat-panel displays, disk heads and the like. For example, lithography is used to transmit a pattern on a mask or reticle to a resist layer on a substrate through spatially modulated light. The resist layer is then developed and the exposed pattern is either etched away (positive resist) or remains (negative resist) to form a three dimensional image pattern in the resist layer. However, other forms of lithography are employed in addition to photoresist lithography.

In one form of lithography used in the semiconductor industry a wafer stepper is employed, which typically includes a reduction lens and illuminator, an excimer laser light source, a wafer stage, a reticle stage, wafer cassettes and an operator workstation. Modern stepper devices employ both positive and negative resist methods, and utilize either the original step-and-repeat format or a step-and-scan format, or both. In semiconductor wafer processing, the wafer substrate material undergoes a series of processing steps typically including doping, oxidation, deposition, lithography, etching and chemical mechanical polishing (CMP), among others. These steps result in formed patterns on the surface of the substrate. The formed patterns typically are semiconductor device components, and must be faithfully reproduced within close tolerances in order for the device to function. It is thus necessary to determine how faithfully the desired patterns are created on the surface of the wafer in order to have the end product device meet required specifications. Creation of the desired patterns within specifications is, in turn, largely a function of process parameters. Metrology tools are employed to measure the created patterns. The measured patterns are then compared to the desired patterns and process engineers, either directly or by means of a computer-based process control system, decide how to adjust the process steps in order to obtain patterns meeting the desired specifications.

Pattern surface measurements include critical dimensions (CD), profile characteristics and other parameters. Some semiconductor metrology instruments directly measure patterned surfaces while other instruments infer the patterned surfaces. Direct measurement tools use techniques which directly measure the patterning. Inference tools produce a measured signal related to the patterns and then infer the patterning.

Direct measurement tools are typified by scanning electron microscopes (SEM), atomic force microscopes, other electron microscopes, optical microscopes and similar devices. However, while SEM metrology can resolve features below 0.1 microns, the process is costly, requires a high vacuum chamber, is relatively slow in operation and is difficult to automate. Optical microscopes can be employed, but do not have the required resolving power for sub-micron structures.

One tool which infers the measurement is an optical scatterometer. Other inferential measurement tools include ellipsometers, reflectometers, and, in general, any spectroscopic diffraction-based technique employing any form of electromagnetic radiation. A variety of scatterometer and related devices and measurements can be used to characterize the microstructure of microelectronic and optoelectronic semiconductor materials, computer hard disks, optical disks, finely polished optical components, and other materials having lateral dimensions in the range of tens of microns to less than one-tenth micron. For example, the CDS200 Scatterometer, made and sold by Accent Optical Technologies, Inc. is a fully automated nondestructive critical dimension (CD) measurement and cross-section profile analysis system, partially disclosed in U.S. Pat. No. 5,703,692. This device can repeatably resolve critical dimensions of less than 100 nm while simultaneously determining the cross-sectional profile and performing a layer thickness assessment. This device monitors the intensity of a single diffraction order as a function of the angle of incidence of the illuminating light beam. The intensity variation of the 0^{th} or specular order as well as higher diffraction orders from the sample can be monitored in this manner, and this provides information that is useful for determining the properties of the sample target which is illuminated. Because the process used to fabricate the sample target determines the properties of a sample target, the information is also useful as an indirect monitor of the process. This methodology is described in the literature of semiconductor processing. A number of methods and devices for scatterometer analysis are taught, including those set forth in U.S. Pat. Nos. 4,710,642, 5,164,790, 5,241,369, 5,703,692, 5,867,276, 5,889,593, 5,912,741, 6,100,985, 6,137,570, and 6,433,878, each incorporated herein by reference.

Scatterometers and related devices can employ a variety of different methods of operation. In one method, a single, known wave-length source is used, and the incident angle Θ is varied over a determined continuous range. In another method, a number of laser beam sources are employed, optionally each at a different incident angle Θ. In yet another method, an incident broad spectral light source is used, with the incident light illuminated from some range of wavelengths and the incident angle Θ optionally held constant. Variable phase light components are also known, utilizing optics and filters to produce a range of incident phases, with a detector for detecting the resulting diffracted phase. It is also possible to employ variable polarization state light components, utilizing optics and filters to vary the light polarization from the S to P components. It is also possible to adjust the incident angle over a range φ, such that the light or other radiation source rotates about the target area, or alternatively the target is rotated relative to the light or other radiation source. Utilizing any of these various devices, and combinations or permutations thereof, it is possible and known to obtain a diffraction signature for a periodic structure.

Besides scatterometer devices, there are other devices and methods capable of determining the diffraction signatures at the 0^{th} order or higher diffraction orders using a light-based source that can be reflected off of or transmitted through a periodic structure, with the light captured by a detector. These other devices include ellipsometers and reflectometers. It is further known that non-light-based diffraction signatures may be obtained, using other radiation sources such as, for example, X-rays.

Varieties of periodic structures are known in the art and are frequently employed as target structures for metrology. A simple and commonly used target is a diffraction grating, essentially a series of periodic lines, typically with a width to space ratio of between about 1:1 and 1:3, though other ratios are known. A typical diffraction grating, at for example a 1:3 ratio, might have a 100 nm line width and a 300 nm space, for a total pitch (width plus space) of 400 nm. The width and pitch is a function of the resolution of the lithographic process, and thus as lithographic processes permit smaller widths and pitches, the width and pitch may similarly be reduced. Diffraction techniques can be employed with any feasible width and pitch, including those substantially smaller than widths and pitches now typically employed.

Diffraction gratings or other target periodic structures are typically dispersed in a known pattern within dies on a wafer. CD may be determined using scatterometry by comparing diffraction signatures from a diffraction grating to a theoretical model library of diffraction grating signatures yielding information regarding CD. The actual diffraction measures are compared to the model, from which CD values are derived. Because the optical response of a diffraction grating or other periodic structure can be rigorously simulated from Maxwell's equations, the most common methods are model-based analyses. These techniques rely on comparing the measured scatter signature to signatures generated from a theoretical model. Both differential and integral models have been explored. Because these diffraction models are computationally intensive, standard regression techniques generally cannot currently be utilized without introducing errors due to the performance of the regression, but if the errors are small or tolerable, a regression approach can be used. Generally, however, the model is used a priori to generate a series of signatures that correspond to discrete iterations of various grating parameters, such as its thickness and the width of the grating lines. The set of signatures that results when all parameters are iterated over some range of values is known as a signature library. When the scatter signature is measured, it is compared against the library to find the closest match. Standard Euclidean distance measures, such as minimizing the mean square error (MSE) or root mean square error (RMSE), are used for identifying the closest match. The parameters of the modeled signature that agrees most closely with the measured signature are taken to be the parameters of this measured signature.

U.S. Patent Application Publication No. 2002/0035455, to Niu and Jakatdar, is typical of a model based system employed to generate a library of simulated diffraction signals of a periodic structure. In the general method, a library is generated based on an assumed theoretical profile of a periodic structure, optionally taking into account parameters such as characterization of the film stack of the periodic structure, the optical properties of materials used in forming the periodic structure, assumed ranges of hypothetical parameters, resolution used to generate the library constituent members, and the like. However, the method of U.S. Patent Application Publication No. 2002/0035455, typical of the prior art, begins the process by assuming the shape and other parameters of the periodic structure. Other similar disclosures include U.S. Patent Application Publication Nos. 2002/0112966, 2002/0131040, 2002/0131055 and 2002/0165636.

Inference tools typically cannot measure an unknown pattern, which is to say determine relevant CD or other parameters, without first utilizing some form of “hint”. One type of hint is a single pattern and the corresponding diffraction signal resulting from the single pattern, which is representative of the expected pattern. Another type of hint is a set of model patterns and the corresponding diffraction signals which are designed to either include the expected pattern or to include a model pattern within the instrument's accuracy and precision of any expected patterns. Analysis of the measured signal, guided by the hint, results in an inference of the actual patterning.

A major problem in the analysis is supplying the correct hints. When the hint is one or more model patterns, the equipment user must be supplied with a method for entering the pattern. The most common solution heretofore is to supply a graphical user interface (GUI) with which the user draws the pattern. For example, the GUI can supply the user with a set of predefined shapes which may be incorporated into the desired pattern. The user may also specify the material of which each shape is made. In this manner, a complex model pattern may be built up. On submission, the model pattern must be checked for physical reasonableness.

If a set of model patterns is desired, then the user must specify how the shapes may change. For example, a rectangle is specified by width and height. To create a model pattern set, the user can enter a range of widths and heights as well as the stepping within the ranges.

Sets of model patterns are not very useful in themselves. However, a library of model signals may be derived from a model pattern set. Model signal libraries are extremely useful. A model signal library is constructed based on simulation of the model patterns utilizing Maxwell's equations. The simulation may be complex, and include factors such as CD, relevant pitches, focus, exposure, resist type, resist thickness, temperature, numerical aperture, substrate composition, material composition and the like.

If a single model pattern is submitted, then the analysis employed usually incorporates some type of error minimization algorithm. The error is the difference between the measured signal and a model signal. The model signal is derived from the model pattern such that if the model pattern and measured pattern are the same, then the model signal and measured signal are the same. Minimizing the error is usually an iterative process in which the analysis algorithm calculates the error and then uses the error, as well as previous error calculations, to generate a new model pattern. In order to generate a new model pattern, the analysis must choose a shape to change and how to change it.

These various prior art methods have a number of significant limitations. Many patterns cannot be easily built up from primitive shapes. Thus an interface that employs primitive shapes that are joined together to form a pattern may not be able to construct the desired pattern. Changing shapes in a pattern description is poorly correlated with how patterns change due to process variations; thus minor changes in pattern description may involve significant, and frequently inappropriate, process variation changes. Construction methods employing primitive shapes is time consuming for complex patterns. Additionally, the skills required for making a pattern using prior art methods, essentially a drafting process, are not necessarily consonant with the expertise of process engineers and others who typically use such methods.

There is thus a need for a method of generating a model of the periodic structure which overcomes the limitations of the prior art, and preferably which method is related to the actual process of making.

### SUMMARY OF THE INVENTION (DISCLOSURE OF THE INVENTION)

In one embodiment the invention provides a method of specifying a model pattern of a diffracting structure for use in semiconductor metrology, the diffracting structure to be fabricated on a semiconductor substrate employing a lithographic process, in which method a series of process steps to be employed in fabrication of a diffracting structure on a semiconductor substrate employing a lithographic process are specified, and the series of process steps are simulated to thereby produce a model pattern of the diffracting structure. The method can further include the step of generating a simulated diffraction signal from the model pattern of the diffracting structure. In this method, the specified series of process steps can include selection of data in a database related to fabrication of the diffracting structure on a semiconductor substrate. Thus series of process steps can include a lithography process step, such as specifying lithography patterns from lithography mask data. Other process steps can include oxidation, vapor deposition, spin-on deposition, etching, chemical mechanical polishing or strip process steps. The series of process steps can be specified by entry of data in a computer-executable program, with simulating the series of process steps including execution of the program.

In a related embodiment, the invention provides a method of making a library of simulated diffraction signals of a diffracting structure fabricated on a semiconductor substrate for use in semiconductor metrology, in which method a series of process steps employed in fabrication of a diffracting structure on a semiconductor substrate and associated process variances for each process step are specified, the series of process steps and associated process variances to produce a set of model patterns of the diffracting structure are simulated, and simulated diffraction signals are generated from members of the set of model patterns of the diffracting structure. This method can further include obtaining a diffraction signature of the diffracting structure on a semiconductor substrate and comparing the diffraction signature of the diffracting structure to the simulated diffraction signatures of members of the set of model patterns of the diffracting structure. In this method, parameters associated with a model pattern producing a close match simulated diffraction signal can be modified and simulated diffraction signatures of the modified model pattern produced, and if found a closer match simulated diffraction signature is selected.

In this method a diffraction signature of the diffracting structure on a semiconductor substrate is obtained by use of a radiation source-based tool. The radiation source-based tool can be a light source-based tool. The light source-based tool can include an incident laser beam source, an optical system focusing the laser beam and scanning through some range of incident angles, and a detector for detecting the resulting diffraction signature over the resulting measurement angles. The light source-based tool can thus include an angle-resolved scatterometer. The light source-based tool can also include a plurality of laser beam sources. In a related embodiment, the light source-based tool includes an incident broad spectral light source, an optical system focusing the light and illuminating through some range of incident wavelengths, and a detector for detecting the resulting diffraction signature over the resulting measurement wavelengths. In yet another related embodiment, the light source-based tool includes an incident light source, components for varying the amplitude and phase of the S and P polarizations, an optical system focusing the light and illuminating over some range of incident phases, and a detector for detecting the phase of the resulting diffraction signature. Obtaining a diffraction signature of the diffracting structure on a semiconductor substrate can include phase measurement by means of a broad spectral radiation source-based tool source, operating at a fixed angle, a variable angle Θ or a variable angle φ. Obtaining a diffraction signature of the diffracting structure on a semiconductor substrate can alternatively include phase measurement by means of a single wavelength radiation source-based tool source, operating at a fixed angle, a variable angle Θ or a variable angle φ. In yet another related embodiment, obtaining a diffraction signature of the diffracting structure on a semiconductor substrate can include phase measurement by means of a multiple discrete wavelength radiation source-based tool source. Obtaining a diffraction signature of the diffracting structure on a semiconductor substrate can include obtaining a reflective diffraction signature or obtaining a transmissive diffraction signature. The diffraction signature of the diffracting structure can be a specular order diffraction signature or a higher order diffraction signature. In this method, generating simulated diffraction signatures of members of the set of model patterns of the diffracting structure can employ submission to a remote computer on a computer network, and additionally can include embodiments wherein results are retrieved from or returned by the remote computer.

In yet another embodiment the invention provides a method of inferentially measuring at least one parameter associated with a diffracting structure fabricated on a semiconductor substrate by means of a radiation-based tool, in which method a series of two or more process steps employed in fabrication of a diffracting structure on a semiconductor substrate and one or more associated process variances for each process step are specified, the series of process steps and associated process variances are simulated to produce a set of model patterns of the diffracting structure, simulated diffraction signatures of members of the set of model patterns of the diffracting structure are generated, a diffraction signature of the diffracting structure on a semiconductor substrate is obtained by means of a radiation-based tool, the diffraction signature of the diffracting structure is compared to the simulated diffraction signatures of members of the set of model patterns of the diffracting structure and a close match simulated diffraction signature is selected, and at least one parameter associated with the diffracting structure is derived by examination of the model pattern generating a close match simulated diffraction signature. In this method a step of modifying one or more parameters associated with a model pattern producing a close match simulated diffraction signature, and comparing the simulated diffraction signature thereof to the diffraction signature of the diffracting structure, can also be employed.

The invention thus encompasses a computer program, residing on a computer-readable medium, which program includes instructions for causing a computer to receive input on a series of process steps employed in fabrication of a diffracting structure on a semiconductor substrate, determine one or more effects of each of the process steps in the fabrication of the diffracting structure, and produce a graphic representation of a model pattern derived from the one or more effects of each of the process steps in the fabrication of the diffracting structure.

The invention further includes a graphic user interface method for a generating a graphic model pattern of a diffracting structure fabricated on a semiconductor substrate, in which method inputs from a user to select process steps to be employed in modeling fabrication of a diffracting structure on a semiconductor substrate are received, at least one input to specify an order in which to simulate the selected process steps is provided, and a graphic representation of a model pattern of the diffraction structure derived from one or more effects of each of the process steps in the fabrication of the diffracting structure is displayed. In the graphic user interface method, a user interface to edit one or more process steps, such editing linked to display of the graphic representation of the model pattern of the diffraction structure derived from one or more effects of the edited one or more process steps, can be employed. Inputs received in the method can include specifying values of one or more process parameters associated with selected process steps. Thus the values of one or more process parameters can include values of the variance of the process parameters. The graphic user interface method can further include receiving inputs of process properties. The inputs can include properties of materials employed in modeling fabrication of a diffracting structure on a semiconductor substrate. In the method, a graphic representation of a simulated diffraction signal generated from the model pattern of the diffracting structure can be displayed.

A primary object of the present invention is to provide a method for constructing a library of diffraction signatures or other inferred electromagnetic measuring parameters relating to a diffracting structure utilizing a method based on the fabrication process parameters of the diffraction structure.

Another object of the present invention is to provide a method for construction a library of diffraction signatures or other inferred electromagnetic measuring parameters utilizing a graphic user interface.

Another object of the present invention is to provide a method for determining or measuring parameters relating to a diffracting structure utilizing a library modeled on structures obtained by simulation of semiconductor wafer processing steps.

Another object of the present invention is to provide a method for determining or measuring parameters associated with a lithography device by obtaining a diffraction signature utilizing any method to create a diffraction signature, including but not limited to reflective or transmissive angle-resolved, variable wavelength, variable phase, variable polarization state or variable orientation diffraction, or a combination thereof, of the 0^{th} or specular diffraction order or any higher orders, and comparison of the results thereby obtained to a library modeled on structures obtained by simulation of semiconductor wafer processing steps.

Another object of the present invention is to provide a method and device for determining or measuring parameters associated with a lithography device as a function of focus, dose or other process parameters by means of a library modeled on structures obtained by simulation of semiconductor wafer processing steps, including the desired parameters.

Another object of the present invention is to provide a method for determining or measuring parameters associated with a lithography device by means of any order of diffraction signature of diffracting structures, including the 0^{th} or specular order or any higher order diffraction, either positive or negative.

A primary advantage of the present invention is that it permits measuring parameters relating to a lithography device without the use of optical, SEM or similar microscopy metrology tools.

Another advantage of the present invention is that it provides a method that permits generating a library of structures and the corresponding library of resulting diffraction signatures based on process parameters employed in fabrication of the physical structure, such as a diffracting structure, by means of modeling by simulation of the semiconductor wafer processing steps.

Yet another advantage of the present invention is that process engineers may create model patterns based on process parameters used in actual fabrication of the semiconductor, and thus employ parameters, data and methodologies both relevant to the process of making and within the skill set of the process engineer.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a flow chart of operational steps of a method of generating model patterns by simulation of semiconductor wafer fabrication and processing steps according to one embodiment of the invention;

FIG. 2 is a graphic representation of a blank silicon wafer;

FIG. 3 is a graphic representation of the silicon wafer of FIG. 2 further including an oxidation layer of silicon dioxide;

FIG. 4 is a graphic representation of the silicon wafer of FIG. 3 further including a developed photoresist layer;

FIG. 5 is a graphic representation of the silicon wafer of FIG. 4 further including the result of an etch step to remove material exposed to the etching process;

FIG. 6 is a graphic representation of the silicon wafer of FIG. 5 further including the result of a strip step to remove photoresist;

FIG. 7 is a graphic representation of the silicon wafer of FIG. 6 further including the result of a vapor deposition step, such as a conformal aluminum layer;

FIG. 8 is a graphic representation of the silicon wafer of FIG. 7 further including the result of a chemical mechanical polishing step;

FIG. 9 is a graphic representation of a model pattern obtainable by an embodiment of the invention and depicting an undercut profile;

FIG. 10 is a graphic representation of a model pattern obtainable by an embodiment of the invention and depicting a footing profile;

FIG. 11 is a graphic representation of a model pattern obtainable by an embodiment of the invention and depicting a post profile periodic structure with periodicity in two directions; and

FIG. 12A to 12C is an exploded schematic representation of a wafer with dies thereon, the dies including diffraction gratings, wherein FIG. 12A depicts the wafer, FIG. 12B depicts a die including a diffraction grating set on the wafer of FIG. 12A, and FIG. 12C depicts an individual diffraction grating on the die diffraction grating set of FIG. 12B.

### DESCRIPTION OF THE PREFERRED EMBODIMENTS (BEST MODES FOR CARRYING OUT THE INVENTION)

The invention provides systems and methods for generating model patterns and model pattern libraries together with derived model signals and model signal libraries, wherein the method of developing model patterns is based on the actual processes which a semiconductor wafer undergoes. These systems and methods present a number of advantages. In one embodiment, any pattern which can be produced can be modeled, limited only by the process model. Thus the ability to “draft” or otherwise specify a completed pattern is not required. New model patterns are generated via adjustments similar to those of the actual wafer fabrication process. Patterns only need to be drawn for the lithography step. If the pattern is generated using current techniques, then fewer primitive shapes are required. In general, lithography pattern data necessarily exists, and is required for the lithography mask. The mask data can be used in a process of automatically generating the pattern. Process engineers necessary know exactly what processing steps and parameters will be employed in wafer lithography. Frequently this information has been entered into a database or is otherwise readily accessible, generally through computer-based systems. The process variation of most of the steps is well known. Thus it can be seen that existing data may be used to automatically generate either a single model pattern or an entire library of patterns.

The processing steps must be simulated in the systems and methods of this invention. Many process steps have previously been simulated individually and, sometimes, in combination. In general, the purpose for which the steps have been simulated in the prior art is to understand the physics and characteristics of the step itself. These process simulations are generally designed for physical accuracy which is in excess of that required for generating model patterns. In any event, such simulations have not been used to produce model patterns for use with an inference based metrology tool.

Before proceeding to further describe the invention, the following definitions are given.

A lithography device refers to any device that utilizes an image, such as a mask, to transfer a pattern to and optionally into a substrate. This thus includes conventional optical lithography, such as photoresist lithography, but also includes other methods of lithography. In photoresist lithography, also called photolithography, optical methods are used to transfer circuit patterns from master images, called masks or reticles, to wafers. In this process, one or more specialized materials called resists are coated on the wafers on which the circuits are to be made. A resist coat is applied as required, and as required the wafer is further processed, such as by a softbake. Either positive or negative photoresist materials may be employed. Positive resists are normally insoluble in chemicals used as resist developers, but become soluble by exposure to light. Negative resists are normally soluble in chemicals used as resist developers, but become insoluble by exposure to light. By exposing the resist selectively in some areas but not others, the pattern of the circuit or other structure is created in the resist film. In optical lithography, the selective exposure is accomplished by imaging of a mask, typically by shining light onto the mask and projecting the transmitted image onto the resist film.

The lithography devices referenced in this invention include steppers, also known as wafer steppers, which are used to project the image of a circuit or other structure from a photomask onto a resist-coated wafer. A stepper typically includes reduction lens and illuminator, excimer laser light source, wafer stage, reticle stage, wafer cassettes and an operator workstation. Steppers employ both positive and negative resist methods, and utilize either a step-and-repeat format or a step-and-scan format, or combination thereof.

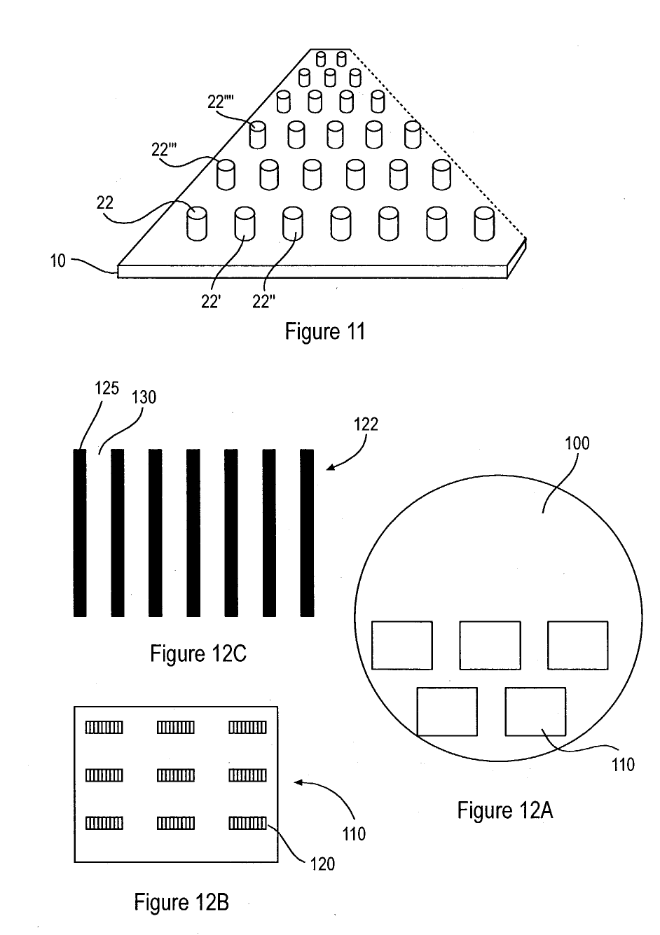

There is employed in the practice of this invention a wafer or other substrate on which is posited a series of periodic structures by means of a lithographic device. One form of periodic structure is a diffraction grating, including any structure or image made by lithographic means which generates a periodic variation of the refractive index relative to an incident illumination. This change in refractive index can be either due to a physical difference or a chemical difference. Physical differences include photoresist or other lithographically generated changes, such as utilizing a material with one refractive index coupled with air, such as ordinary scored optical diffraction gratings, or a material coupled with a different material. Chemical differences include wafers with photoresist exposed diffraction gratings, where the resist has not yet been developed. In this case all of the resist is still present, but the portions that have been exposed have a different refractive index than the non-exposed resist portions, thereby creating a diffraction grating consisting of periodic variations of refractive index in the resist. The periodic difference is obtained by the periodicity of structural or chemical elements. This thus includes conventional diffraction gratings consisting of a series of parallel lines, but also includes gratings such as a three-dimensional array of posts or holes, wherein there is periodicity in both in the X direction and Y direction. A diffraction grating with periodicity in both the X and Y directions is shown in FIG. 11, and a diffraction grating with periodicity in one direction is shown in FIG. 8 and FIG. 12C, with FIG. 12C depicting line 125 and space 130. Diffraction gratings thus include photoresist gratings, etched film stack gratings, metal gratings and other gratings known in the art. The width and pitch of the periodic structure can be any feasible size, depending in large part on the resolution of the lithographic device.

In the practice of this invention, a periodic structure such as a diffraction grating is used to generate a diffraction signature. A diffraction signature can be generated by any of a number of instruments, such as scatterometers, ellipsometers or reflectometers. Any device employing radiation to generate a diffraction signature is referred to herein as a radiation source-based tool. Typically a visible radiation source-based tool, such as a light source-based tool, is employed, but the radiation source may be other than visible radiation, and thus may be any form of electromagnetic radiation, including radiation such as that obtained with an X-ray source. In one embodiment, the diffraction signature is created by a reflective mode, wherein the radiation, such as light, is reflected. Thus a diffraction signature may be generated by means of an angle-resolved scatterometer, wherein a single known wave-length source is used, and the incident angle Θ is varied over a determined continuous range. The resulting diffraction signature can have the intensity of light plotted against the incident and reflective angle Θ. In another method, a number of laser beam sources are employed, optionally each at a different incident angle Θ. In yet another method, an incident broad spectral light source is used, with the incident light illuminated from some range of wavelengths and the incident angle Θ optionally held constant. Variable phase light sources are also known, utilizing a range of incident phases, with a detector for detecting the resulting diffracted phase. Variable polarization light sources are also known, utilizing a range of polarization from the S to P components or the P to S components. It is also possible to adjust the incident angle over a range φ, such that the light source rotates about the diffraction grating, or alternatively the diffraction grating is rotated relative to the light source. Utilizing any of these various devices, and combinations or permutations thereof, it is possible and known to obtain a diffraction signature for a sample target. In general, the detected light intensity is plotted against the at least one variable parameter, such as angle of incidence Θ, wavelength of incident light, phase of incident light, angle of sweep φ or the like. The diffraction signature may represent the 0^{th} or specular diffraction order, or may represent any higher diffraction order. It is also possible and contemplated that a transmissive mode may be employed to generate a diffraction signature, such as by use of an X-ray radiation source as a component of the radiation source-based tool.

In one embodiment of the invention, a wafer 100 as in FIG. 12A is provided, on which is disposed a series of dies 110. Each die, as illustrated in FIG. 12B, typically represents that portion of the wafer representing the exposure field of the lithographic device, such as a stepper. In a step-and-repeat system, the entire area of the mask or reticle to be exposed is illuminated when the shutter is opened, thereby simultaneously exposing the entire die exposure field. In a step-and-scan system, only a part of the reticle or mask, and thus only a part of the die exposure field, is exposed when the shutter is opened. In either event, the reticle or mask may be moved such that a diffraction grating set 120 is produced, the diffraction grating set 120 being composed of a series of different, optionally different focus, diffraction gratings, with a diffraction grating 122 shown at FIG. 12C, which diffraction grating 122 forms a part of diffraction grating set 120. It is also possible that the diffraction grating set 120 is composed of a series of the same diffraction gratings, or is composed of a series of diffraction gratings varying by one or more process parameters, such as focus, dose or the like. It is also possible that from die to die on a wafer 100, one or more process parameters, again such as dose range or focus setting range or both, may vary. Conventionally, the dose or focus is varied in constant incremental steps, thereby facilitating subsequent analysis. Thus the focus, for example, might vary in 50 to 100 nm steps over a determined range, and the dose, for example, might vary in 1 or 2 mJ increments over a determined range.

The diffraction gratings are typically created in a resist material by preparing masks with opaque and transparent areas corresponding to the desired shape, size and configuration of the desired diffraction grating. A source of radiation is then applied on one side of the mask, thereby projecting the mask shape and spaces onto the resist layer, the resist layer being on the opposite side of the mask. One or more lens or other optical systems may be interposed between the mask and the resist layer, and also optionally between the radiation source and the mask. When exposed to radiation or energized at sufficient levels to effect a change in the resist, a latent image is formed in the resist. The latent images, representing a chemical change in the resist material, result in changes in reflectivity of the resist layer, and thus may be employed to generate a diffraction signature as set forth above. In one embodiment, the wafer with latent images in the resist may be subjected to a post-exposure bake, used to drive additional chemical reactions or to diffuse components within the resist layer. In yet another embodiment, the resist may be developed by a development process, optionally a chemical development process, whereby a portion of the resist is removed, such portion determined by whether a positive resist or negative resist was employed. The development process is also referred to as an etching process, resulting in etched areas or spaces of the resist layer, and optionally the substrate material, such as other films, on which such resist layer is posited.

In the methods and devices of this invention, the actual diffraction grating may be exposed but not developed, or may alternatively be developed. Similarly, while the foregoing generally describes a conventional method of generating a diffraction grating, any process method step may be employed, including use of phase shift masks, any of a variety of sources of radiation, including electron beam exposure, and the like. It may readily be seen that for any process method step it is only necessary to model such step, as described herein.

In general, in the practice of the systems and methods of the invention individual process steps are defined and a simulation employed to simulate the effect of such process step on the resulting pattern.

Lithography generally describes the step where patterns are produced on the surface of a substrate. The process includes applying a layer of photoresist, exposing the wafer to modulated energy causing a latent image in the photoresist, and then developing. The entire lithographic process may be simulated by specifying the pattern and the resist thickness. It is also possible to employ additional simulation parameters, including for example focus, exposure, resist type, numerical aperture and the like. More detailed simulation will be required for wafers only part way through the lithographic step, such as wafers that are not developed. A variety of software products are available, such as the Prolith advanced lithography simulation software made by KLA-Tencor Corporation and products by ASML MaskTools, Inc. such as LithoCruiser™ lithography optimization software, which may be employed to model the actual lithography step itself, including lithography parameters, the effect of resist patterning, and the like. While these programs and methods may be employed to model the specific lithography step, the prior art programs and methods do not apply the results reached thereby as a step for generating patterns.

Oxidation is a step where the wafer is exposed to oxygen. Changes in temperature, time, and oxygen density will affect the results. This step may be simulated by specifying the new material, which is an oxide of the exposed material, and the process parameters of temperature, time, and oxygen density.

Vapor deposition is a step where new material is deposited on the surface of a wafer. This is unlike oxidation, where the new material is grown via oxidation of the substrate surface. There are many different vapor deposition technologies, but they all share the properties of building up material at a given rate for a specified time. Hence growth rate and time are sufficient process parameters for a simple simulation. More advanced simulations may simulate different deposition rates for corners and sidewalls, and may also simulate different vapor deposition methods, materials, and the like.

Spin-on deposition is a step where the wafer is spun on a turn table and new material is poured onto it resulting in a fairly uniform coating of the new material. The simplest simulation can simply assume that the step results in a layer of material completely filling any underlying patterns and having a flat surface. Layer thickness can thus define the process. More detailed simulations accounting for material viscosities, spin rates, spin times, and other process variables can be employed.

Etching is a step where material is removed from a surface via chemical reactions and/or ion bombardment. Different materials on the wafer surface will experience different etch rates. The step may be simulated by specifying the material etch rates and time. Detailed simulations may be employed, incorporating parameters such as temperature, material, gas flow rate, gas composition, output power of power supply, power supply modulation, level of vacuum in the processing chamber, reaction products from the etch process, processing duration and the like. For etching process employing substeps, which substeps typically vary temperature, pressure, composition and flows, among other parameters, each such substep may be simulated as part of the etching step simulation.

Chemical mechanical polishing (CMP) is a method of removing material by rubbing the top of the wafer with an abrasive pad. The result is that the topmost material is removed and a fairly flat wafer surface results. The simplest simulation removes all material from the top of the wafer at a given rate for a specified time. More exacting simulations may be employed, including parameters such as pad manufacturer, pad composition, pad operating life, pad condition, pad history, abrasive slurry composition, slurry viscosity, relative velocities between pad and wafer, processing duration and the like.

Strip is a step removing any photoresist remaining from a previous lithography step. The simplest simulation removes all exposed photoresist. More complex simulations can include the type of strip, such as a wet, dry, or ashing strip, chemical composition of solvents used in the stripping process, and the like.

Software methods to simulate each individual process step are known in the art or may be readily adapted from known methods. Commercial software to simulate the lithography process step is described above. A variety of major national and international organizations for the semiconductor industry, such as the Semiconductor Industry Association (SIA), have established roadmaps for Technology Computer Aided Design (TCAD). Under the auspices of TCAD, these organizations have become clearing houses for process simulation software. In general, every semiconductor process step is simulated, and every experimental semiconductor process step is simulated. The simulation of semiconductor technologies is discussed at conferences all over the world, many of them sponsored by organizations such as SIA. Information sources on software for simulation of individual process steps includes IEEE Transactions on Computer-Aided Design of Integrated Circuits and Systems, a monthly publication, and publications of the IEEE Electron Devices Society, including Electron Device Letters, Transactions on Electron Devices and an electronic IEEE publication, Transactions on Technology Aided Design. Any applicable and specific simulation technology or codes may be mixed and matched from the vast supply of software programs, both commercial and public domain, which will simulate a semiconductor process. In the invention disclosed herein, these software programs or routines are applied sequentially in order to create a model pattern which is then used to generate a simulated measurement. Prior art simulation software programs are employed to simulate the effect of a processing step in order to optimize the actual process step; by contrast, in the invention the process specifications are employed to produce simulated measurements for use in construction of a model pattern.

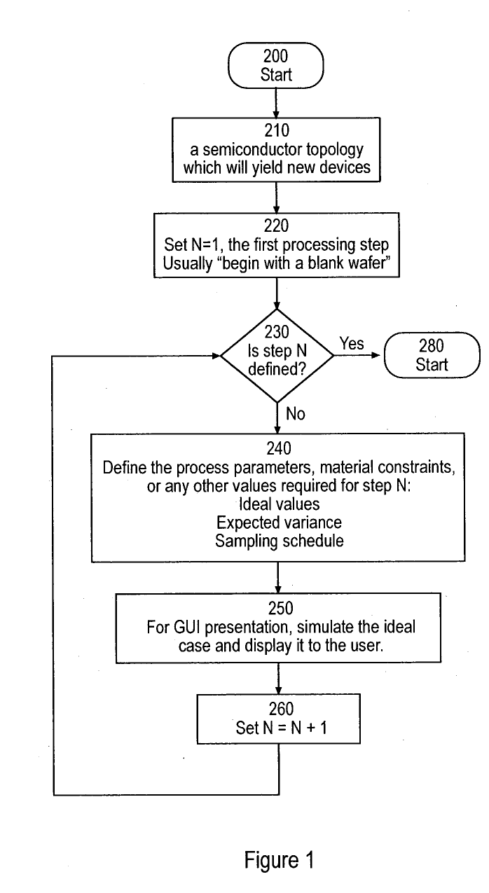

FIG. 1 is a flow chart illustrating how a process engineer may define a model pattern representing a manufacturing process. The flow chart shows a method of defining a recipe which is remarkably similar to way the engineer defines the manufacturing process itself. The process engineer employs the same skill set and basic information for specifying model patterns as for defining the manufacturing process. In FIG. 1, 210 defines a semiconductor topology, such as a manufacturing process, which will be employed to make the device. A series of process steps, as described in 220, are initiated; generally the initial process step is the blank wafer. 230 is a Yes/No function, determining whether the model pattern process parameters for step N are defined. If No, then the process parameters are defined in function 240, resulting in simulation 250 of the ideal case in a graphic user interface (GUI). If simulation 250 is accepted, then in step 260 N is incrementally increased by one, and the process continued for all processing steps until the model pattern is defined.

The application of the flow chart method of FIG. 1 is illustrated by processing steps employed to create a model pattern of an aluminum-silicon dioxide grating over a silicon substrate.

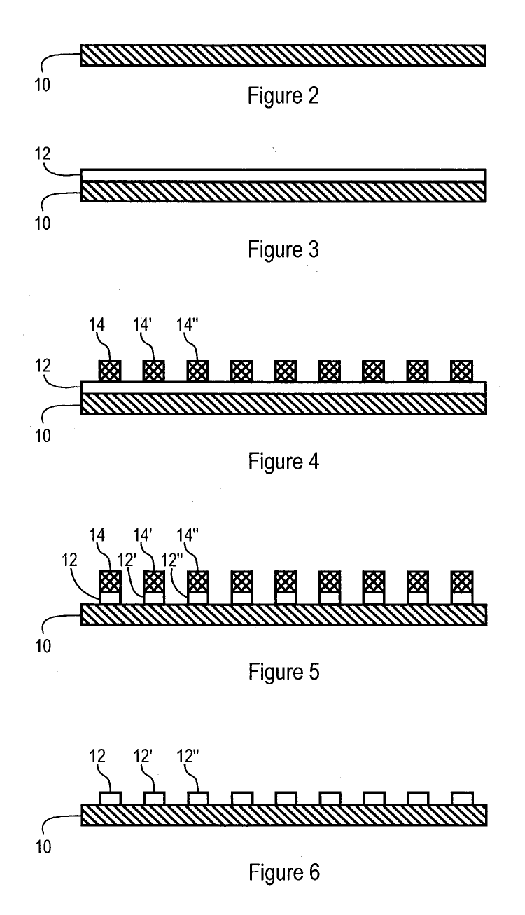

The initial step (N=1) posits a blank silicon wafer 10 as shown in FIG. 2, a two-dimensional cross section of the resulting structure. While a two-dimensional cross section is typically employed, it is to be understand that any graphic representation compatible with the desired objective may be employed, including three-dimensional and views other than cross sections perpendicular to the periodicity of the structure.

The second step (N=2) is oxidation, resulting in a 0.5 micrometer thick layer of silicon dioxide 12 on top of the wafer, as depicted in FIG. 3. Through the use of the GUI the relevant process parameters are specified, resulting in the desired depiction.

The next step (N=3) is lithography, wherein the grating pattern 14, 14′, 14″ is drawn on top of the oxide as shown in FIG. 4. The pattern material is developed photoresist. The result is a silicon substrate, layer of oxide, and a layer of patterned photoresist. Optionally and in a preferred embodiment the grating pattern is directly derived from mask data specified in the manufacturing process itself. As discussed above, any of a variety of process parameters may be specified in this step.

At the etch step (N=4), the material exposed to the etching process is removed at that material's etch rate. The result is a silicon substrate, a patterned layer of oxide 12, 12′, 12″, and a patterned layer of photoresist 14, 14′, 14″ as shown in FIG. 5. The oxide and photoresist have the same general patterning.

At the strip step (N=5) the photoresist is removed, resulting in a silicon substrate and a layer of patterned oxide 12, 12′, 12″ as shown in FIG. 6.

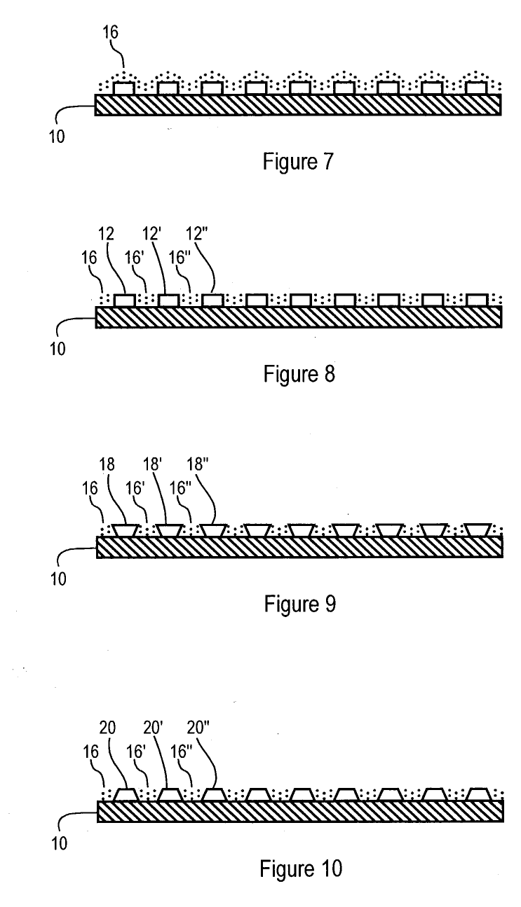

Vapor deposition, such as addition of a layer of aluminum, may take place at the next step (N=6). The result is a silicon substrate, a layer of patterned oxide, and a conformal layer of aluminum 16 as shown in FIG. 7. The aluminum is conformal in that the top surface of the aluminum is not flat, but approximates the patterning depicted below. The aluminum fills the gaps in the oxide patterning.

At the CMP step (N=7) the top-most material is polished away until the oxide layer is reached. The result is a silicon substrate 10 with an oxide 12, 12′, 12″ and aluminum 16, 16′, 16″ grating on top, as shown in FIG. 8.

In this previous example, a conformal layer was created in step N=6. Current techniques used for specifying model patterns have a very difficult time creating conformal layers. The technique of this invention creates conformal layers naturally.

It may readily be seen that other structures may be modeled by appropriate specification of process parameters, such that the result is, for example, an undercut oxide 18, 18′, 18″ as shown in FIG. 9, or a “footing” oxide 20, 20′, 20″ as shown in FIG. 10.

In a preferred embodiment, the invention includes a GUI with which the user enters the process, materials, patterning, and any defining parameters for creating the model patterns. The invention further includes systems, means and methods, generally software driven, for automatically generating the model patterns from various data, including but not necessarily limited to lithography mask data and process data.

Generation of libraries from a model pattern is well known in the art, as disclosed in a number of references, such as U.S. Patent Application Publication Nos. 2002/0035455, 2002/0112966, 2002/0131040, 2002/0131055 and 2002/0165636, among others. Early references to these methods include R. H. Krukar, S. S. H. Naqvi, J. R. McNeil, J. E. Franke, T. M. Niemczyk, and D. R. Hush, “Novel Diffraction Techniques for Metrology of Etched Silicon Gratings,” OSA Annual Meeting Technical Digest, 1992 (Optical Society of America, Washington, D.C, 1992), Vol 23, p. 204; and R. H. Krukar, S. M. Gaspar, and J. R. McNeil, “Wafer Examination and Critical Dimension Estimation Using Scattered Light,” Machine Vision Applications in Character Recognition and Industrial Inspection, Donald P. D'Amato, Wolf-Ekkehard Blanz, Byron E. Dom, Sargur N. Srihari, Editors, Proc SPIE, 1661, pp 323-332 (1992).

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A method of specifying a model pattern of a diffracting structure for use in semiconductor metrology, the diffracting structure to be fabricated on a semiconductor substrate employing a lithographic process, the method comprising:
specifying a series of process steps to be employed in fabrication of a diffracting structure on a semiconductor substrate employing a lithographic process; and
simulating the series of process steps to produce a model pattern of the diffracting structure.

2. The method of claim 1, wherein specifying a series of process steps comprises selection of data in a database related to fabrication of the diffracting structure on a semiconductor substrate.

3. The method of claim 1, wherein specifying a series of process steps comprises specifying lithography patterns from lithography mask data.

4. The method of claim 1, wherein specifying a series of process steps comprises specifying a lithographic process step.

5. The method of claim 4, wherein specifying a series of process steps further comprises specifying at least one process step selected from the group consisting of oxidation, vapor deposition, spin-on deposition, etching, chemical mechanical polishing and strip process steps.

6. The method of claim 1, wherein specifying a series of process steps comprises entry of data in a computer-executable program and simulating the series of process steps comprises execution of the program.

7. A method of making a simulated diffraction signal of a diffracting structure fabricated on a semiconductor substrate, the method comprising:
specifying a series of process steps employed in fabrication of a diffracting structure on a semiconductor substrate;
simulating the series of process steps to produce a model pattern of the diffracting structure;
generating a simulated diffraction signal from the model pattern of the diffracting structure.

8. The method of claim 7, wherein specifying a series of process steps comprises selection of data in a database related to fabrication of the diffracting structure on a semiconductor substrate.

9. The method of claim 7, wherein specifying a series of process steps comprises specifying lithography patterns from lithography mask data.

10. The method of claim 7, wherein specifying a series of process steps comprises specifying a lithographic process step.

11. The method of claim 10, wherein specifying a series of process steps further comprises specifying at least one process step selected from the group consisting of oxidation, vapor deposition, spin-on deposition, etching, chemical mechanical polishing and strip process steps.

12. The method of claim 7, wherein specifying a series of process steps comprises entry of data in a computer-executable program, simulating the series of process steps comprises execution of a first module of the program and generating a simulated diffraction signal comprises execution of a second module of the program.

13. A method of making a library of simulated diffraction signals of a diffracting structure fabricated on a semiconductor substrate for use in semiconductor metrology, the method comprising:
specifying a series of process steps employed in fabrication of a diffracting structure on a semiconductor substrate and associated process variances for each process step;
simulating the series of process steps and associated process variances to produce a set of model patterns of the diffracting structure; and
generating simulated diffraction signals from members of the set of model patterns of the diffracting structure.

14. The method of claim 13 wherein specifying a series of process steps comprises specifying a lithographic process step and associated process variances for the lithographic process step.

15. The method of claim 14, wherein specifying a series of process steps further comprises specifying at least one process step selected from the group consisting of oxidation, vapor deposition, spin-on deposition, etching, chemical mechanical polishing and strip process steps.

16. A method of making a library of simulated diffraction signals of a diffracting structure fabricated on a semiconductor substrate for use in semiconductor metrology, the method comprising:
specifying a series of process steps employed in fabrication of a diffracting structure on a semiconductor substrate and one or more associated process variances for each process step;
simulating the series of process steps and one or more associated process variances to produce a set of model patterns of the diffracting structure;
generating simulated diffraction signatures of members of the set of model patterns of the diffracting structure;
obtaining a diffraction signature of the diffracting structure on a semiconductor substrate; and
comparing the diffraction signature of the diffracting structure to the simulated diffraction signatures of members of the set of model patterns of the diffracting structure.

17. The method of claim 16 further comprising the step of modifying parameters associated with a model pattern producing a close match simulated diffraction signal.

18. The method of claim 16 wherein obtaining a diffraction signature of the diffracting structure on a semiconductor substrate comprises use of a radiation source-based tool.

19. The method of claim 18, wherein the radiation source-based tool comprises a light source-based tool.

20. The method of claim 19, wherein the light source-based tool comprises an incident laser beam source, an optical system focusing the laser beam and scanning through some range of incident angles, and a detector for detecting the resulting diffraction signature over the resulting measurement angles.

21. The method of claim 20, wherein the light source-based tool comprises an angle-resolved scatterometer.

22. The method of claim 19, wherein the light source-based tool comprises a plurality of laser beam sources.

23. The method of claim 19, wherein the light source-based tool comprises an incident broad spectral light source, an optical system focusing the light and illuminating through some range of incident wavelengths, and a detector for detecting the resulting diffraction signature over the resulting measurement wavelengths.

24. The method of claim 19, wherein the light source-based tool comprises an incident light source, components for varying the amplitude and phase of the S and P polarizations, an optical system focusing the light and illuminating over some range of incident phases, and a detector for detecting the phase of the resulting diffraction signature.

25. The method of claim 16, wherein obtaining a diffraction signature of the diffracting structure on a semiconductor substrate comprises phase measurement by means of a broad spectral radiation source-based tool source, operating at a fixed angle, a variable angle Θ or a variable angle φ.

26. The method of claim 16, wherein obtaining a diffraction signature of the diffracting structure on a semiconductor substrate comprises phase measurement by means of a single wavelength radiation source-based tool source, operating at a fixed angle, a variable angle Θ or a variable angle φ.

27. The method of claim 16, wherein obtaining a diffraction signature of the diffracting structure on a semiconductor substrate comprises phase measurement by means of a multiple discrete wavelength radiation source-based tool source.

28. The method of claim 16, wherein obtaining a diffraction signature of the diffracting structure on a semiconductor substrate comprises obtaining a reflective diffraction signature.

29. The method of claim 16, wherein obtaining a diffraction signature of the diffracting structure on a semiconductor substrate comprises obtaining a transmissive diffraction signature.

30. The method of claim 16, wherein the diffraction signature of the diffracting structure is a specular order diffraction signature.

31. The method of claim 16, wherein the diffraction signature of the diffracting structure is a higher order diffraction signature.

32. The method of claim 16, wherein generating simulated diffraction signatures of members of the set of model patterns of the diffracting structure comprises submission to a remote computer on a computer network.

33. The method of claim 32, wherein results of the step are retrieved from or returned by the remote computer.

34. A method of inferentially measuring at least one parameter associated with a diffracting structure fabricated on a semiconductor substrate by means of a radiation-based tool, the method comprising:
specifying a series of two or more process steps employed in fabrication of a diffracting structure on a semiconductor substrate and one or more associated process variances for each process step;
simulating the series of process steps and associated process variances to produce a set of model patterns of the diffracting structure;
generating simulated diffraction signatures of members of the set of model patterns of the diffracting structure;
obtaining a diffraction signature of the diffracting structure on a semiconductor substrate by means of a radiation-based tool;
comparing the diffraction signature of the diffracting structure to the simulated diffraction signatures of members of the set of model patterns of the diffracting structure, and selecting a close match simulated diffraction signature; and
deriving at least one parameter associated with the diffracting structure by examination of the model pattern generating a close match simulated diffraction signature.

35. The method of claim 34 further comprising the step of modifying one or more parameters associated with a model pattern producing a close match simulated diffraction signature, and comparing the simulated diffraction signature thereof to the diffraction signature of the diffracting structure.

36. A computer program, residing on a computer-readable medium, comprising instructions for causing a computer to:
receive input on a series of process steps employed in fabrication of a diffracting structure on a semiconductor substrate;
determine one or more effects of each of the process steps in the fabrication of the diffracting structure; and
produce a graphic representation of a model pattern derived from the one or more effects of each of the process steps in the fabrication of the diffracting structure.

37. A graphic user interface method for a generating a graphic model pattern of a diffracting structure fabricated on a semiconductor substrate, the method comprising:
receiving inputs from a user to select process steps to be employed in modeling fabrication of a diffracting structure on a semiconductor substrate;
providing at least one input to specify an order in which to simulate the selected process steps;
displaying a graphic representation of a model pattern of the diffraction structure derived from one or more effects of each of the process steps in the fabrication of the diffracting structure.

38. The method of claim 37 further comprising employing a user interface to edit one or more process steps, such editing linked to display of the graphic representation of the model pattern of the diffraction structure derived from one or more effects of the edited one or more process steps.

39. The method of claim 37 wherein receiving inputs further comprises specifying values of one or more process parameters associated with selected process steps.

40. The method of claim 39 wherein values of one or more process parameters further comprise values of the variance of the process parameters.

41. The method of claim 37 further comprising the step of receiving inputs of process properties.

42. The method of claim 37 further comprising the step of receiving inputs of properties of materials employed in modeling fabrication of a diffracting structure on a semiconductor substrate.

43. The method of claim 37 further comprising displaying a graphic representation of a simulated diffraction signal generated from the model pattern of the diffracting structure.
